(19) United States
(12) Patent Application Publication
(10) Pub. No.: US 2023/0002026 A1
(43) Pub. Date: Jan. 5, 2023

(54) DEPLOYABLE HYDROGEN REACTOR

(71) Applicant: Massachusetts Institute of Technology, Cambridge, MA (US)

(72) Inventors: Erik Limpaecher, Concord, MA (US); Eric Morgan, Bolton, MA (US)

(73) Assignee: Massachusetts Institute of Technology, Cambridge, MA (US)

(21) Appl. No.: 17/722,228

(22) Filed: Apr. 15, 2022

Related U.S. Application Data
(60) Provisional application No. 63/211,707, filed on Jun. 17, 2021.

(51) Int. Cl. B64B 1/62; C01B 3/08

(52) U.S. Cl. CPC B64B 1/62; C01B 3/08

(57) ABSTRACT

Systems and methods related to deployable hydrogen reactors are described. In some embodiments, a system (e.g., a balloon system) may include a reaction chamber immersed in a body of water. By permitting a flow of water from the body of water into the reaction chamber, a reaction between a reactant and the water may be carried out to produce one or more lifting gases (e.g., hydrogen gas), which can be employed to subsequently inflate and launch the system in an automated fashion.

### CROSS-REFERENCE TO RELATED APPLICATIONS

This application claims the benefit under 35 U.S.C. § 119(e) of U.S. provisional application Ser. No. 63/211,707, filed Jun. 17, 2021, the disclosure of which is incorporated by reference in its entirety.

### GOVERNMENT LICENSE RIGHTS

This invention was made with government support under FA8702-15-D-0001 awarded by the U.S. Air Force. The government has certain rights in the invention.

### FIELD

Disclosed embodiments are related to deployable reactors.

### BACKGROUND

High-altitude balloons, also called near-space balloons, often operate at altitudes above 80,000 feet, and sometimes operate at altitudes in excess of 100,000 feet. The balloons are filled with a gas that is less dense than air, such as helium or hydrogen, which produces a buoyant force that is capable of lifting a payload. High-altitude balloons have numerous civilian and military applications, including weather monitoring, communications, and imagery. These systems are, however, constrained by the infrastructure required for their deployment.

### SUMMARY

In one embodiment, a system for producing hydrogen gas includes: a reaction chamber configured to contain a reactant that reacts with water to generate hydrogen gas; an inlet in fluid communication with an exterior environment the reaction chamber is at least partially immersed in; and a one way valve disposed along a flow path extending between the inlet and the reaction chamber, wherein the one way valve is configured to permit a liquid to flow from the exterior environment into the reaction chamber to react the reactant with the liquid.

In one embodiment, a method of filling a balloon includes: immersing, at least partially, a reaction chamber in an exterior environment containing water such that water flows from the exterior environment into an inlet of the reaction chamber, combining the water and a reactant contained within the reaction chamber to produce hydrogen gas; and flowing the hydrogen gas into a balloon to increase a buoyancy of the balloon.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of a perspective view of a system for producing hydrogen gas, according to some embodiments;

FIG. 2 is a schematic representation of an exploded view of the system of FIG. 1, according to some embodiments;

FIG. 3 is a schematic representation of a method of using a system to inflate a balloon system, according to some embodiments;

FIG. 4 is a schematic representation of the method of FIG. 3 illustrating inflation and launch of a balloon system, according to some embodiments;

FIG. 5 is a schematic representation of the system during inflation, according to some embodiments;

FIG. 6 is a schematic representation of the system during the course of flight, according to some embodiments; and

FIG. 7 is a flow diagram of one embodiment of a method for controlling an altitude of a balloon system.

### DETAILED DESCRIPTION

High-altitude balloons have numerous applications, including for weather monitoring, communications, and imagery. These systems are, however, constrained by the infrastructure required for their deployment. The infrastructure typically includes a specialized building which houses bulky, heavy steel tanks for storing high-pressure hydrogen gas or helium gas.

Furthermore, specialized high-pressure gas plumbing may be needed to reduce safety risk associated with transport and handling of the high-pressurized gas. In situations where hydrogen gas is used, the infrastructure often require additional construction to eliminate spark hazards. The transport of steel storage tanks for hydrogen or helium may also be logistically burdensome.

In addition to the above, ground based inflation and launch of balloon systems may have various challenges. For example, to deploy balloons under high wind conditions from the ground, specialized launch bags may be required to restrain the balloon to the ground to prevent the balloon from contacting sharp objects that can result in puncturing and damage to the balloon. Furthermore, to avoid excess heating caused by the depressurizing gas, inflation of small and medium-sized balloons from steel tanks may take a relatively long period of time. Similarly, shipboard applications, for which the communication capabilities of high-altitude balloons are particularly useful, may also pose challenges. For example, the storage, production, and/or handling of high-pressure gas (e.g., hydrogen gas) aboard vessels may pose potential safety concerns.

In view of the above, the Inventors have appreciated that the need for a system for producing hydrogen gas that does not require specialized infrastructure, and is easy and safe to transport and handle. In particular, the Inventors have recognized the need for a system that may be capable of producing hydrogen gas when the system is at least partially immersed in a body of water. In instances in which the system is used to provide hydrogen gas for inflating a balloon, this may permit the balloon to be inflated and launched directly from a body of water (e.g., sea, ocean, river, lake, etc.). Such a system may advantageously remove the need for specialized infrastructure, bulky hydrogen gas storage tanks, and at the same time, bypasses the difficulties associated with ground based inflation and launch of typical balloon systems, e.g., such as the potential for puncturing of balloons during high wind conditions. However, other applications of the disclosed systems for producing hydrogen are also contemplated.

While various embodiments herein are related to systems (e.g., balloon systems) and methods directed to applications in a body of water, it should be understood that the disclosure is not limited, and in certain cases, the system may also be employed in ground based applications. Compared to conventional systems, the systems described herein may also exhibit certain advantages for ground base applications, e.g., such as the ability to produce hydrogen gas, a lack of need for cumbersome infrastructure, as well as automated hydrogen generation processes in addition to other potential benefits.

Certain aspects of the present disclosure are directed to a system for producing hydrogen gas. In some embodiments, the system comprises a reaction chamber configured to contain a reactant that is capable of reacting with water to generate a gas, e.g., such as hydrogen gas. In some embodiments, the reactant comprises one or more of a metal and/or alloy thereof. Non-limiting examples of the reactant are described in more detail below.

In some embodiments, the reaction chamber is at least partially immersed in an exterior environment. In some cases, the exterior environment may contain a liquid comprising water. For example, the exterior environment may be a body of water, such as an ocean, a lake, a river, a pond, and/or any other body of water. Non-limiting examples of a liquid comprising water may include freshwater, brackish water, seawater, contaminated water, salt water, water comprising one or more solutes, etc.

In some embodiments, a substantial portion (e.g., at least 50 vol %, 60 vol %, 70 vol %, 80 vol %, 90 vol %, 95 vol %, 99 vol %, or all) of the reaction chamber may be immersed in an exterior environment. In some embodiments, the reaction chamber comprises an inlet, and the reaction chamber may be immersed in the exterior environment to an extent such that the inlet of the reaction chamber is in fluidic communication (e.g., direct fluidic communication) with the exterior environment. For example, in some instances, when the inlet of the reaction chamber may be in fluidic communication with the exterior environment, the inlet may permit a liquid from the exterior environment to flow into the reaction chamber via the inlet.

In some embodiments, the system further comprises a one way valve disposed along a flow path extending between the inlet and an interior of the reaction chamber. That is, the one way valve may be positioned in any appropriate location along a path which a liquid entering into the inlet of the reaction chamber travels to reach the inside of the reaction chamber. In some cases, the one way valve may be configured to permit unidirectional flow of a liquid from an exterior environment into the interior of the reaction chamber and to prevent backflow of the liquid from reaction chamber. As described in more detail below, the one way valve, by permitting a liquid to flow from the exterior environment into the reaction chamber, may in turn allow the reactant contained with the reaction chamber and the influent liquid (e.g., water) to combine and react to form hydrogen gas.

As described in more detail below, the system may further include additional components, e.g., such a balloon, a ballast, one or more controllers, one or more sensors, one or more valves or vents, various types of payloads, etc., that impart the system with various enhanced capabilities. For example, the various components described herein may allow for automated inflation and launch of the balloon system in a body of water, as well as automated buoyancy and/or altitude controls prior to the launch and/or while in flight.

Certain aspects of the present disclosure are also directed to a method for filling and/or using the hydrogen generating systems described herein. In some embodiments, the method first comprises immersing, at least partially, a reaction chamber containing one or more reactants in an exterior environment containing a liquid that comprises water. The exterior environment and liquid may be any of a variety of environment and liquid described elsewhere herein. In one set of embodiments, a substantial portion (e.g., at least 50 vol %, at least 60 vol %, at least 70 vol %, at least 80 vol %, at least 90 vol %, at least 95%, or all) of the reaction chamber is immersed in the exterior environment. Alternatively, in some embodiments, the reaction chamber may be immersed in the exterior environment to an extent such that an inlet of the reaction chamber is in fluid communication with the exterior environment. As such, the liquid may flow from the exterior environment into the reaction chamber via the inlet of the reaction chamber. As the liquid flows in the reaction chamber, the water from the liquid may combine with the reactant contained within the reaction chamber to undergo one or more chemical reactions to produce hydrogen gas. In some cases, other gases, e.g., such as steam, may also be produced from the reaction. The one or more gases may in turn flow through an outlet from the of the reaction chamber. For example, in some embodiments, the provided gas may flow from the outlet into a balloon fluidically connected to the reaction chamber to increase a buoyancy of the balloon though other applications may also be used. As described in more detail below, the buoyancy of the system may be controlled via one or more automated buoyancy and/or altitude controls.

In some embodiments, a reaction chamber comprises an inlet configured to receive an inlet flow of liquid from an exterior environment. The reaction chamber may further comprise an outlet configured to flow a gas produced (e.g., hydrogen gas, etc.) in the reaction chamber into an inlet of an attached balloon. In some embodiments, the inlet of the reaction chamber may comprise an inlet flow control. The inlet flow control may be a gate valve, a ball valve, a butterfly valve, or any other suitable valve that can control the flow of a liquid from the exterior environment into the inlet of the reaction chamber. In some embodiments, the inlet flow control may be in the form of a one way valve configured to allow a liquid to flow into the inlet, while preventing the liquid from flowing out of the inlet into the exterior environment. As described in more detail below, the inlet flow control may be optionally controlled by a controller. As such, the inlet flow control may be operated such that the inlet and/or associated valve is configured to open when the reaction is immersed in the exterior environment. The inlet, when in an open state or otherwise operated to permit flow of a liquid, may be in fluid communication with an exterior environment such that a liquid from the exterior environment is permitted to travel through the inlet into the reaction chamber.

In one set of embodiments, the reaction chamber may comprise a controller configured to open the inlet based at least in part on an initiation signal. For example, the controller, upon receiving the initiation signal, may be configured to actuate the inlet and associated valve to open and permit flow of a liquid from an exterior environment into the reaction chamber. In some cases, the initiation signal may be generated by a sensor positioned on an exterior of the reaction chamber. The sensor may, in some cases, be configured to sense a parameter associated the exterior environment. For example, upon sensing a parameter associated with the exterior environment, the sensor may generate an initiation signal that is in turn delivered to the controller. The controller, upon receive the initiation signal, may be configured to actuate the inlet to transition to an open state, thereby permitting flow of a liquid from the exterior environment into the reaction chamber. Any of a variety of a suitable sensors may be employed, including but not limiting to, a liquid level sensor, a pressure sensor, an oxygen sensor, a temperature sensor, a flow sensor, etc. Non-limiting examples of a parameter that may be sensed include H₂O, liquid level, oxygen level, pressure, temperature, flow, etc.

In some embodiments, the reaction chamber may comprise vessel walls comprising a non-porous material. The non-porous material may be watertight and/or gas tight, e.g., such that a liquid from an exterior environment and/or the generated gaseous products (e.g., hydrogen and/or oxygen) is incapable of diffusing or transferring across the vessel walls.

In some embodiments, the systems disclosed herein may include a balloon in fluid communication with the reaction chamber. The inlet of the balloon may be connected to an outlet of the reaction chamber. As noted above, via the outlet of the reaction chamber, the balloon may be configured to receive a gaseous product (e.g., a hydrogen gas, steam) produced from the reaction chamber. In some embodiments, the one way valve coupled to the inlet of the reaction chamber, by preventing counterflow of liquid from the reaction chamber into the exterior chamber, may force the gaseous product to flow into the outlet of the reaction chamber and into the inlet of the balloon.

In some embodiments, the system comprises a mechanism configured to detach the balloon from the reaction chamber. In one set of embodiments, upon inflation and prior to lift off, the balloon may be configured to detach from the reaction chamber. For example, in some cases, the balloon may be configured to detach from the reaction chamber based on an elapsed reaction time associated with the reaction occurring within the reaction chamber. Alternatively or additionally, the balloon may be configured to detach from the reaction chamber based on a particular lift force resulting from the gaseous products (e.g., hydrogen gas) formed in the reaction. When the elapsed reaction time and/or lift force exceed a threshold value, the balloon may be filled with an amount of gas (e.g., hydrogen and steam) sufficient for the balloon to lift off and increase in altitude. It should also be noted that the present disclosure is not so limited, and that in other embodiments, the balloon may stay attached to the reaction chamber (and associated components) as an integrated system at all times (e.g., take off, in flight).

In some embodiments, the balloon may be made from any suitable material. For instance, the material may be capable of withstanding a temperature and/or pressure associated with the steam and hydrogen gas in the balloon. For instance, the material may be any suitable polymers or elastic polymers. In some instances, the polymer may be hydrophobic polymers. Non-limiting examples of the material include uncured latex, polyamide, polydimethylsiloxane (PDMS), etc. In some instance, a material that is capable of continual operation at temperatures of up to about 100° C. may be chosen.

In some embodiments, the system further comprises an altitude controller configured to control buoyancy of the system (e.g., balloon system). For example, upon receiving commands from the altitude controller, the system may be configured to increase or decrease the buoyancy of the system during the course of the flight. The altitude controller may comprise a processor operatively coupled to one or more sensors and other components of the system for detecting an altitude of the system. For example, using information from the sensors, the processor may control the buoyancy of the system based on input from the one or more sensors for sensing the altitude of the balloon. The altitude controller may communicate with the system wirelessly or via a wired connection. In some embodiments, the system may additionally include a memory associated with the processor. The memory may include instructions that when executed by the processor perform the methods described herein. Of course, it should be understood that while embodiments related to the use of sensors have been described, embodiments in which sensors are not used are also contemplated.

In some embodiments, the reaction chamber may further comprise a ballast dispensing assembly for storing and dispensing ballasts. For example, in some embodiments, waste products formed in the reaction chamber may be stored for use as ballast in the ballast dispensing assembly. The ballast dispensing assembly, in some cases, may be configured to dispense waste product to increase an buoyancy of the system either prior to the lift off, during the lift off, and/or during the course of flight. As described in more detail below, the waste products stored in the ballast dispensing assembly may be configured to open or close during the course of the flight to release the waste products as ballast based on commands received from an altitude controller. In some cases, storing the waste products as ballast may advantageously eliminate the need for external ballasts and reduces the overall weight of the balloon system.

In some embodiments, a payload may be attached to the system described herein. Any of a variety of desired payload may be attached to the system, depending on the desired application. The payload may serve various purposes, including, but not limited to, serving as a buoyancy control for the system and/or comprising an article capable of performing a desired function. For example, the payload may be employed in to control the buoyancy of the system in an exterior environment (e.g., a body of water) in which the reaction chamber is at least partially immersed in. In some embodiments, the payload may have a neutral buoyancy, a negative buoyancy, or a positive buoyancy relative to the liquid in the exterior environment. In some embodiments, a positively buoyant payload may make it possible for the system to stay at least partially afloat on a surface and/or sub-surface of the exterior environment. Conversely, a negatively buoyant payload may make it possible for a part of the system to sink to the bottom of the exterior environment. In some instances, the buoyancy of the payload may be varied accordingly to allow for inflation and/or launch of the system from a body of water, e.g., such as shore-based and/or sea-based inflation and launch of the system, and/or a variety of application in the body of water, e.g., such as undersea applications including undersea salvage and undersea logistics stores.

As noted above, the reaction chamber comprises a reactant capable of reacting with water to form hydrogen gas. The reactant may be disposed in any appropriate locations within the reaction chamber. The presence of such a reactant in the system may advantageously allow for in situ generation of hydrogen gas when the system is at least partially immersed in an exterior environment (e.g., a body of water), and thereby removing the need for any additional infrastructure (e.g., tanks for carrying hydrogen gas and/or water). The use of such a reactant may increase the ease and safety of manufacturing, handling, transporting of the system.

Without wishing to be bound by theory, hydrogen gas and steam may be produced by combining a reactant with water within the reaction chamber. For instance, in some embodiments, the reactant may include at least one selected from the group of aluminum, lithium, sodium, magnesium, zinc, boron, beryllium, tin, other metallic compounds that are reactive with water to form hydrogen, and alloys thereof. For example, using aluminum or an alloy of aluminum as the reactant, hydrogen may be produced according to one or more of the reactions (depending on the ambient temperature):

2Al(s)+4H₂O(l)↔3H₂(g)+2AlO(OH)(s) (1)

2Al(s)+6H₂O↔+3H₂+2Al(OH)₃(s) (2)

The Inventors have appreciated that this chemical reaction may produce both hydrogen gas, heat, and a waste product. Additionally, in some embodiments, steam may be generated from the resultant heat of reaction. In some cases, the hydrogen gas and steam (if formed) may be used to increase the buoyant force acting on a balloon. Reactions 1 and 2 above are both exothermic, meaning they release heat. In addition to the generation of heat, the reactions produce hydrogen gas (the desired product) and hydroxides of aluminum (a byproduct). e.g., specifically aluminum oxide hydroxide (AlO(OH)) and aluminum trihydroxide (Al(OH)₃). In some embodiments, a waste product (e.g., aluminum hydroxide) associated with the aforementioned reactions may be used as a ballast for altitude control of a balloon. For example, the waste product may be dropped to decrease the weight of the balloon system. As such, a system that employs this chemical reaction and/or another similar chemical reaction may allow for increased system lift. Additionally, in some embodiments, the steam, after condensing, may be used as a ballast for additional altitude control of a balloon. For instance, via a combination of conductive and/or convective heat transfer through the balloon itself and/or another appropriate heat transfer structure, at least a portion of the steam inside a balloon may condense into water condensate. The water condensate may be used as a ballast and dropped to decrease the weight of the balloon system.

In some embodiments, the reactant comprises an activated metal capable of reacting with water to produce hydrogen gas. For example, the reactant further comprises an activating composition that is permeated into the grain boundaries and/or subgrain boundaries of the reactant to facilitate its reaction with water. A variety of materials may be suitable for activating a metal (e.g., aluminum). For example, in some embodiments, the activating material comprises indium (e.g., indium metal). In some embodiments, the activating material comprises gallium (e.g., gallium metal). In some embodiments, the activating material comprises a mixture of gallium and indium. In some embodiments, one or more activating materials is present. In some embodiments, the one or more activating materials includes at least one selected from the group of indium and gallium. However, other activating materials are possible, as this disclosure is not so limited. Non-limiting examples of other activating materials may include tin and alloys thereof (e.g., a tin-alloy comprising indium and/or gallium). In some embodiments, the activating composition may advantageously facilitate reaction of the reactant with water.

For embodiments comprising two or more activating materials (e.g., a first activating material and a second activating material, indium and gallium), the two or more activating materials may each independently be present in a particular ratio. In some embodiments, a molar ratio of indium and gallium is at least 1:1, at least 1.1:1, at least 1.2:1, at least 1.5:1, at least 1.7:1, at least 2:1, at least 2.5:1, at least 3:1, at least 5:1, or at least 10:1. In some embodiments, a molar ratio of indium and gallium is less than or equal to 10:1, less than or equal to 5:1, less than or equal to 3:1, less than or equal to 2.5:1, less than or equal to 2:1, less than or equal to 1.7:1, less than or equal to 1.5:1, less than or equal to 1.2:1, less than or equal to 1.1:1, or less than or equal to 1:1. Combinations of the foregoing ranges are also possible (e.g., at least 1:1 and less than or equal to 10:1). Of course, other ranges are possible as this disclosure is not so limited.

The activating metal (e.g., gallium and/or indium) may be present in a particular amount relative to the activated metal (or a metal to be activated), such as activated aluminum. For example, in some embodiments, the activating metal is greater than or equal to 0.1 wt %, greater than or equal to 1 wt %, greater than or equal to 2 wt %, greater than or equal to 3 wt %, greater than or equal to 4 wt %, greater than or equal to 5 wt %, greater than or equal to 7 wt %, greater than or equal to 10 wt %, greater than or equal to 12 wt %, or greater than or equal to 15 wt % relative to the activated metal. In some embodiments, the activating metal is less than or equal to 15 wt %, less than or equal to 12 wt %, less than or equal to 10 wt %, less than or equal to 7 wt %, less than or equal to 5 wt %, less than or equal to 4 wt %, less than or equal to 3 wt %, less than or equal to 2 wt %, less than or equal to 1 wt %, or less than or equal to 0.1 wt % relative to the activated metal. Combinations of the foregoing ranges are also possible (e.g., greater than or equal to 0.1 wt % and less than or equal to 15 wt %, relative the activated metal). Of course, other ranges are possible as this disclosure is not so limited.

In some embodiments, the shape and/or size of the reactant may be tailored to a size suitable for the specific application using methods understood to a person of ordinary skill in art. In some embodiments, the shape and size of the reactant may be chosen to optimize the surface contact with water. For example, in some embodiments, the size of the reactant may be altered using milling and/or jet cutting, laser cutting, and/or any other appropriate manufacturing method. Additionally, the reactant may have any appropriate physical form including plates, pellets, powders, blocks, and/or any other form as the disclosure is not limited in this fashion.

In some embodiments, the reactant may be solid. The solid reactant may be provided in discrete pieces, such as pellets. The pellets may be regularly shaped, such as spherical, or may be irregularly shaped chunks. The size of the pellets may be uniform or varied. Alternatively, the solid reactant may be provided in a more continuous form, such as a powder with any appropriate size distribution for a desired application. Of course, a combination of pellets and powder may also be used and/or different forms of a solid reactant may be used, as the disclosure is not limited in this regard. Without wishing to be bound by theory, the size of the individual elements may influence the operation of the system. For example, smaller individual pieces of reactant may have a larger surface area for a given total volume, yielding a faster reaction when combined with water. As such, a powder may be desirable over a pellet form of reactant in some applications when a faster reaction is desired.

In some embodiments, a reactant may be provided in the form of solid particles. In some embodiments, the diameter of the particles may be at least 10 micrometers, at least 50 micrometers, at least 100 micrometers, at least 500 micrometers, at least 1000 micrometers, or at least 1500 micrometers. In some embodiments, the diameter of the particles may be no more than 2000 micrometers, no more 1500 micrometers, no more 1000 micrometers, no more 500 micrometers, no more than 100 micrometers, or no more than 50 micrometers. Combinations of the above-referenced ranges are possible (e.g., between approximately 10 micrometers to 2000 micrometers, 10 micrometers to 50 micrometers). Any other appropriate size range depending on the particular embodiment. Alternatively, in other embodiments, a reactant may be provided in the form of a slurry that combines the reactant material with a non-reactive liquid carrier. For example, a slurry may include particles of the reactant material suspended in an inert fluid. In some embodiments, the fluid may be an oil, such as mineral oil, canola oil, or olive oil. In other embodiments, the fluid may be a grease, alcohol, or other appropriate material capable of suspending the reactant material in solution. The particles in the slurry may have a diameter in one or more of the ranges described above.

In some embodiments, the reaction chamber may contain one or more additives capable of facilitating the reaction between the reactant and water from various types of liquid or exterior environments described elsewhere herein. For example, the one or more additives may allow for reaction between the reactant and purified water, brackish water, seawater, salt water, water containing other contaminants or solutes, etc. Without wishing to be bound by theory, in some cases, the one or more additives may be capable of sequestering and/or removing one or more species (e.g., a solute, an ions, a contaminant, etc.) from various type of water, thereby preventing the one or more species from participating and/or interfering with the reaction between the reactant and water. In some embodiments, the additives may be capable of removing (e.g., displacing) ions that bind to the reactant and/or coat the surface of the reactant, e.g., such that the ions are prevented from participating in the reaction. Non-limiting examples of additives include caffeine, benzotriazole, etc.

some embodiments, the system described herein may be stored in a compact state prior to being deployed or used (e.g., inflated or launched). For example, when the system is in a compact state, the balloon may be in a folded state. In some cases, various types of packaging may be employed to store the balloon in a compact state. In some instances, prior to use, the system may be sealed using a waterproof packaging or wrapper (e.g., a plastic material) to prevent water from entering into the system during storage and transport.

The balloon system, when in a compact state, may have relatively small dimensions. The small size of the compact balloon system may increase the ease of storage and transportation of the system. In some embodiments, the system in a compact state may have a maximum cross-sectional dimension (e.g., a width, a length, a height, etc.) that is greater than or equal to 4 inches, 5 inches, 6 inches, 7 inches, 8 inches, 9 inches, 10 inches, 11 inches, 12 inches, 13 inches, 15 inches, 16 inches, 17 inches, 18 inches, or 19 inches. In some embodiments, the system in a compact state may have a maximum cross-sectional dimension (e.g., a width, a length, a height) that is less than or equal to 20 inches, 19 inches, 18 inches, 17 inches, 16 inches, 15 inches, 14 inches, 13 inches, 12 inches, 11 inches, 10 inches, 9 inches, 8 inches, 7 inches, 6 inches, or 5 inches. Combinations of the above-referenced ranges may be possible (e.g., greater than or equal to 6 inches and less than or equal to 12 inches, greater than or equal to 12 inches or less than or equal to 18 inches, etc.). Other ranges are also possible.

In some embodiments, within the reaction chamber, the water and the reactant may be combined at a water to reactant mass ratio (i.e., weight ratio) of greater than or equal to 8:1, greater than or equal to 9:1, greater than or equal to 10:1, greater than or equal to 12:1, greater than or equal to 14:1, greater than or equal to 16:1, greater than or equal to 20:1, greater than or equal to 24:1, greater than or equal to 28:1, greater than or equal to 32:1, or greater than or equal to 36:1. In some embodiments, the water and the reactant may be combined at a water to reactant mass ratio of less than or equal to 40:1, less than or equal to 36:1, less than or equal to 32:1, less than or equal to 28:1, less than or equal to 24:1, less than or equal to 20:1, less than or equal to 16:1, less than or equal to 14:1, less than or equal to 12:1, less than or equal to 10:1, less than or equal to 9:1. Combinations are also possible (e.g., greater than or equal to 8:1 and less than or equal to 28:1, or greater than or equal to 8:1 and less than or equal to 40:1). Other ranges may be possible.

Certain embodiments comprise flowing hydrogen gas and steam (if present) generated from reactions (1) and/or (2) into a balloon to increase a buoyancy of the balloon, though other applications are also contemplated. In some cases, a total amount of hydrogen gas and steam (if present) may be generated to fill or inflate the balloon within a desired time frame. For instance, aforementioned mentioned parameters (e.g., water to reactant ratio, react composition, etc.) may be configured to generate sufficient hydrogen gas and steam (if present) to inflate a balloon in less than or equal to 10 minutes, less than or equal to 8 minutes, less than or equal to 5 minutes. In some such embodiments, the hydrogen gas and steam (if present) may be produced and/or filled at a volumetric flowrate of greater than or equal to 2,000 L/min, greater than or equal to 5,000 L/min, greater than or equal to 8,000 L/min. greater than or equal to 10.000 L/min, greater than or equal to 20.000 L/min, greater than or equal to 50.000 L/min, or greater than or equal to 80,000 L/min. In some embodiments, the hydrogen gas and steam (if present) may be produced and/or filled at a volumetric flowrate of less than or equal to 100,000 L/min, less than or equal to 80.000 L/min, less than or equal to 50,000 L/min, less than or equal to 20,000 L/min, less than or equal to 10,000 L/min, or less than or equal to 7,000 L/min, or less than or equal to 4,000 L/min. Combination of the above-referenced ranges are possible (e.g., 20,000 L/min to 100,000 L/min, or greater than or equal to 2,000 L/min to 100,000 L/min). Of course, any suitable rate of gas generation may be used depending on the desired application.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

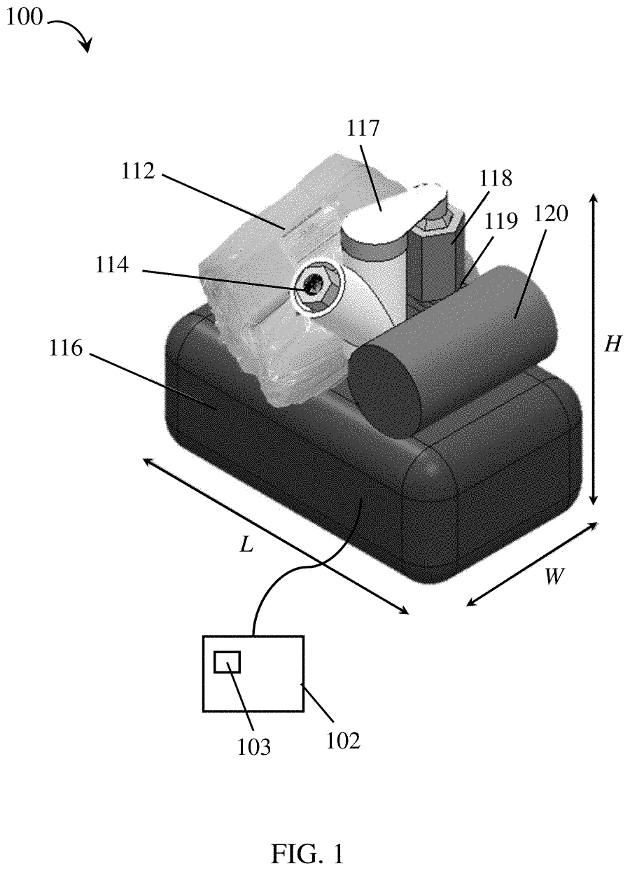

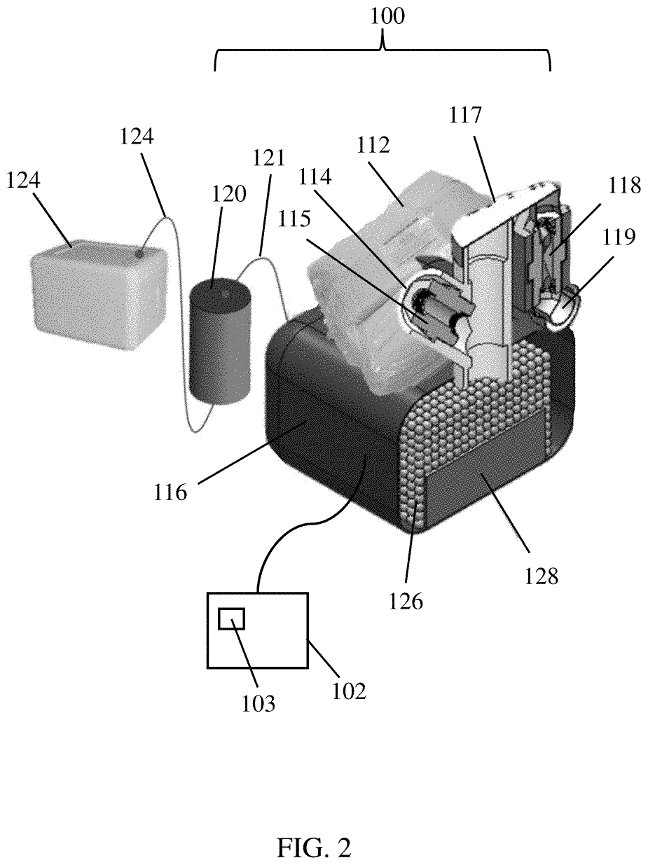

FIG. 1 is a schematic representation of one embodiment of a balloon system 100 in a compact state for producing hydrogen gas. FIG. 2 is an exploded view of the balloon system 100 in FIG. 1. As shown in FIG. 1, the system 100 may comprise a reaction chamber 116 and a balloon 112 that is in fluidic communication with the reaction chamber 116 via a tether 125. In some embodiments, the system described herein may be stored in a compact state prior to being deployed or used. When the system 100 is in a compact state, the 112 balloon has not been inflated and may be in a folded state. The balloon system, when in a compact state (e.g., as shown in FIGS. 1-2), may have relatively small dimensions. For example, the balloon system in a compact state may individually have a width W, a length L. and height H in one or more of the ranges describe elsewhere herein, e.g., such as between 6 and 12 inches, between 12 inches and 18 inches, and between 12 inches and 18 inches, respectively. Though other dimensions may also be used.

The balloon system 100 may contain a variety of components described elsewhere herein. As shown in FIGS. 1-2, the balloon system 110 may include a reaction chamber 116 configured to contain a reactant 126 (e.g., activated aluminum) capable of reacting with water to generate hydrogen, steam (optionally), and waste products (e.g., as illustrated by Eqs. (1)-(2)). The reactant 126 may be in any appropriate shape and form as described elsewhere herein, e.g., such as in the form of solid particles. In some instances, the solid reactant particles may be arranged in an ordered fashion to maximum utilization of space within the reaction vessel, as shown in FIG. 2. The reaction chamber 166 may optionally contain one or more additives capable of sequestering and/or removing one or more solutes or ions in order to prevent the solute and ions from binding to the reactant, as described elsewhere herein. According to some embodiments, the vessel walls of the reaction chamber 116 may be formed via a non-porous and/or waterproof material, e.g., such that liquid from an exterior environment does diffuse into the reaction chamber 116 through the vessel walls and that the generated hydrogen gas does not diffuse out of the reaction chamber 116.

The reaction chamber 116 may further comprise a manifold 117 fluidically connected to the interior of the reaction chamber. A portion of the manifold may form an inlet 114 of the reaction chamber 116. The inlet 114 may be configured to permit a flow of liquid from an exterior environment (e.g., a body of water) into the reaction chamber 116. In some cases, the inlet 114 may comprise one or more valves 115 and/or on/off switch configured to open and close the inlet based at least in part on instructions received from a controller (102) and/or one or more sensors (103). For example, one or more processors which may be included in the controller may be operatively coupled to the one or more sensors and other components of the system for controlling the inlet 114 or an associated valve 115 of the reactor chamber 116. For example, using information from the sensors, the processor may actuate the inlet 114 to open or close. In one such embodiment, the one or more sensors may sense a parameter (e.g., liquid level, H₂O, etc.) of the exterior environment. If the sensors sense that the reactor chamber 116 is immersed in an exterior environment containing a liquid comprising water, the processor may generate commands to open the inlet. e.g., such that the inlet is in fluid communication with an exterior environment that the reaction chamber is at least partially immersed in. As such, the inlet may be configured to allow flow of the liquid from the exterior environment into the reaction chamber. In some instances, when the sensors detect that the amount of liquid entering into the reaction chamber has reached a threshold amount and/or that the reaction chamber has been sufficiently filled up, the sensor communicates with the processor which then directs the system to close the inlet. Such feedback control may allow the system 100 to operate stably. Of course, feedback may be performed on parameters different than liquid level or H₂O detection. The one or more sensors may include temperature sensors, pressure sensors, chemical sensors, light sensors, acoustic sensors, force sensors, strain sensors, accelerometers, gyroscopes, or any other suitable sensors. In some embodiments, the system may additionally include a memory associated with the processor. The memory may include instructions that when executed by the processor perform the methods described herein. Of course, it should be understood that while embodiments related to the use of sensors have been described, embodiments in which sensors are not used are also contemplated. Additionally, in some embodiments, a reactor may include multiple processors, and the processors may control multiple aspects of the system. Further, in some applications, the inlet may not be regulated at all or may be partially regulated.

As shown in FIG. 2, the valve 115 coupled to the inlet 114 of the reaction chamber may be a one way valve. The one way valve 115 may be disposed along a flow path extending between the inlet 115 and the reaction chamber 116. The one way valve 115 may be configured to permit a liquid (e.g., water) to flow from the exterior environment into the reaction chamber 116 to react the reactant 126 with water, and prevent backflow of the liquid from the reaction chamber.

As shown in FIGS. 1-2, the reaction chamber 116 may further comprise an outlet 119 in fluid connection with the inside of the balloon 112. The outlet 119 may be configured to permit a flow of hydrogen gas and steam (if any) formed from the reactions described elsewhere herein from the reaction chamber 116 into the balloon 112. The outlet 118 of the reaction chamber 116 may be coupled to a valve or regulator 118 (e.g., a float valve) capable of preventing liquid from entering and/or accumulating inside the balloon 112.

Optionally, in some cases, the reactor chamber may include one or more additional mechanisms for outlet flow control. For example, in some cases, the system 100 may include a regulator (not shown) coupled to the outlet 119 of the reactor chamber 116 configured to regulate the outlet pressure and/or flow rate of the gas produced in the reactor chamber 116 through the outlet. In some embodiments, a regulator may be a pressure regulator, a flow regulator, a regulator that regulates both pressure and flow, and/or any other suitable type of regulator as the disclosure is not limited in this regard. The outlet flow control may be a valve, a pump, or any other suitable mechanism configured to selectively control delivery and/or flow of a material. When the outlet flow control is open or otherwise operated to permit the flow of gas, hydrogen gas and steam (when present) may flow from the reactor chamber 116, through the outlet 119, and into the balloon 112. When the outlet flow control is closed or otherwise operated to prevent the flow of gas, hydrogen gas and stream (when present) may be prevented from flowing into the balloon 112. Further, in some applications, the one or more outlets may not be regulated at all.

As shown in FIG. 2, the reaction chamber 116 may further comprise a ballast dispensing assembly 128 for storing and dispensing ballasts. In some cases, the ballast comprises a waste product (e.g., aluminum hydroxides) formed by the reaction between the reactant 126 and water within the reaction chamber 116. For example, in some cases, waste products formed in the reaction chamber 126 may be stored for use as ballast in the ballast dispensing assembly 128 (e.g., a rotary dispenser). As described in more detail below, the ballast dispensing assembly 128 may be configured to release the stored waste products as ballast based on commands received from an altitude controller when the system is in flight.

The reactor chamber 116 may be any appropriate reactor. For example, the reactor chamber may be a stir bar reactor, a vibration reactor, a bed reactor, and/or any other appropriate reactor. In some embodiments, the reactor chamber is a continuously stirred tank reactor. High-altitude balloons may operate in cold environments in which a reactor chamber may become cold. A cold reactor chamber may limit the efficacy of the reaction. As such, in some embodiments, the reactor chamber may include heaters, insulation, or other protection against cold. Heaters may include excess heat from an associated processing unit, waste heat from other components of the balloon system, electrical resistance heaters, furnaces, or any other suitable device for providing heat.

As shown in FIGS. 1-2, the balloon system 100 may include an altitude controller 120 that is configured to communicate wirelessly with the system while the system is in flight. As shown in FIG. 2, the altitude controller 120 may be attached to reaction chamber 116 via a tether 121 and may be the configured to control buoyance of the balloon system during deployment or the course of flight. As described elsewhere herein, the altitude control may comprise a processor and/or sensors capable detecting the altitude and/communicating with the system to control the buoyancy of the system.

As shown in FIG. 2, a payload 124 may be attached to the depicted system 100. According to some embodiments, the payload 124 may be employed to control buoyancy of the system when the system is at least partially immersed in the exterior environment. As described in more detail below, the type of payload may vary depending on the type of target application.

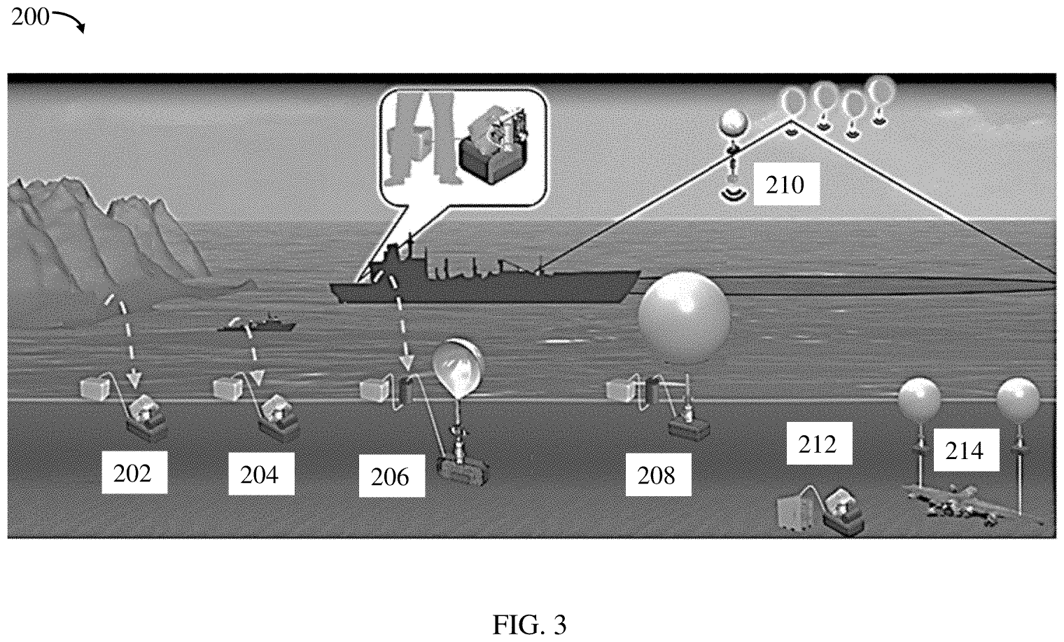

FIG. 3 is a schematic representation of using the system of FIG. 1 for shore-based and/or sea-based applications, according to some embodiments. As shown by 202, 204, and 206, the system may be attached to a payload (e.g., payload 124 as illustrated in FIG. 2) and deployed in a number of ways, e.g., such as from the shoreline (e.g., as shown by 202), from a craft (e.g., as shown by 204), or from a ship (e.g., as shown by 206). Prior to deploying the system and the attached payload into the body of water, the waterproof packaging around the system may be removed to expose the water inlet and associated inlet one way valve. The desired payload may be attached to the system via a tether and attachment mechanism (e.g. carabiner). In one set of embodiments, the payload may be in a watertight enclosure that has a positive buoyancy, e.g., such that sustained water-immersion of the payload during the inflation and launch of the system may be avoided. The positively buoyant payload may also make it possible for the system to stay partially afloat during the inflation and launch.

It should be noted that although FIG. 3 illustrates an embodiment in which the system and attached payload is deployed into the sea. However, the disclosure is not so limited, and that in other embodiments, the system and attached payload maybe deployed into any bodies of water, including, but not limited to, an ocean, lake, river, pool, or other body of water. It may be particularly advantageous to deploy the system and attached payload to a body of water where the area of water surrounding the system is large or open enough. e.g., such that the balloon can inflate under the windy conditions without striking into an obstacle or an object that may puncture it.

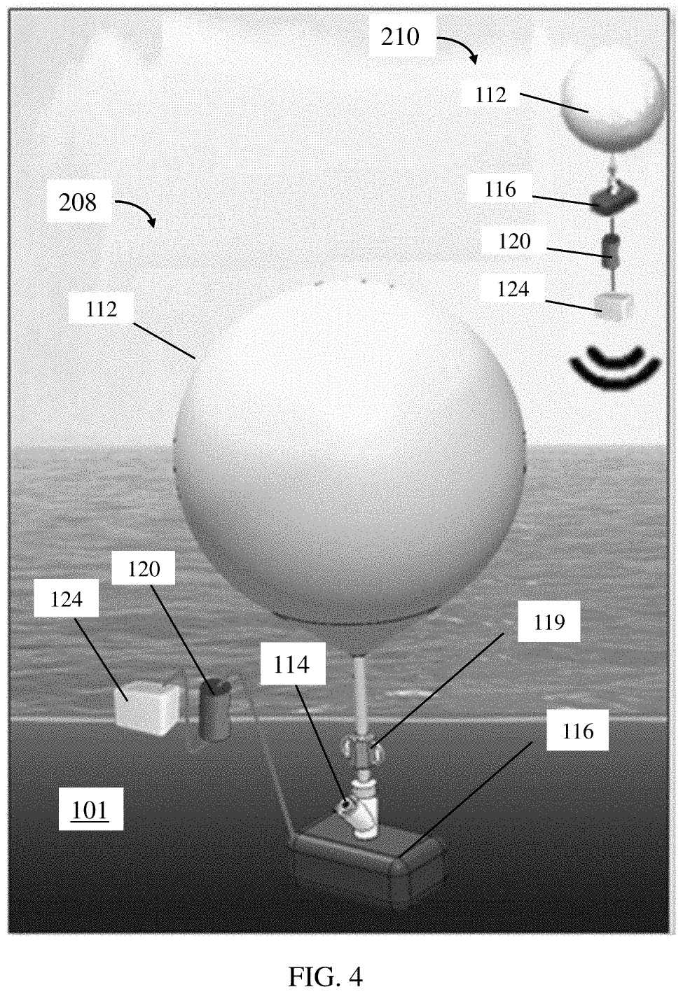

As shown by 208 and 210, upon deploying the system into the sea using one of the modes described with respect to 202, 204, and 206, the balloon system may be inflated and subsequently launched from the sea. FIGS. 4-6 shows detailed schematic illustration of the system during the inflation process (208) and launching process (210).

In some embodiments, the system described herein may be employed in various applications involving a body of water (e.g., the sea). FIG. 3 illustrates an example of an application in the deep sea. For example, as shown by 212, the depicted system may be attached to a payload having a negative buoyancy. e.g., such as a logistic storage, for undersea logistics storage applications. In another example, as shown by 213, the depicted system may be attached a payload, e.g., such as a plane, for undersea salvage applications.

Although FIG. 3 describes using the depicted system in applications involving deployment in the sea, any appropriate a body of water may be used (e.g., shore-based inflation and launch, and sea-based inflation and launch). Additionally, it should be noted that the present disclosure is not limited to deployment in a body of water and that in certain embodiments, the system and method described herein may also be employed for ground based inflation and launch, as long as a source of water may be flowed into the reaction chamber. The depicted system may allow for launch of high-altitude balloons without the need for any infrastructure. e.g., such as buildings, electric power, fresh water, high-pressure plumbing, or steel tanks containing hydrogen. Moreover, the system described herein may advantageously eliminate manual handling of the balloon and reduce the need for personnel training. Furthermore, the system described herein is a fully automated system that allows for automated inflation and launch of the balloon.

In FIGS. 4-6, during the inflation process 208, part of the system 100 (e.g., such as the reaction chamber 116) may be a at least partially immersed in an exterior environment 101, e.g., such as the sea. As such, the inlet 114 is in fluid communication with the exterior environment 101 and may permit a liquid 132 (e.g., seawater) to flow into the reaction chamber 116 from the exterior environment 101 via the water inlet 114. The one way valve 115 coupled to the inlet may allow the liquid 132 (e.g., seawater) to enter the reaction chamber 116 but prevent the liquid from counterflowing. Once the liquid flows through the valve 115 and into the reaction chamber 116, a reactant 126 may combine with the liquid and reacts with water from the liquid 132 to produces hydrogen gas, waste products, and in some instances, steam. For example, in embodiments in which the reactant is aluminum or an alloy of aluminum with an activating composition, hydrogen gas and waste products (e.g, aluminum hydroxides) may be produced according to Eqs. (1) and (2), as described above. In some cases, steam may also be generated from the heat of reaction from the reactions (1) and (2). The generated heat may be sufficiently large relative to the water volume within the reaction chamber that at least a portion of the water is vaporized to form steam.

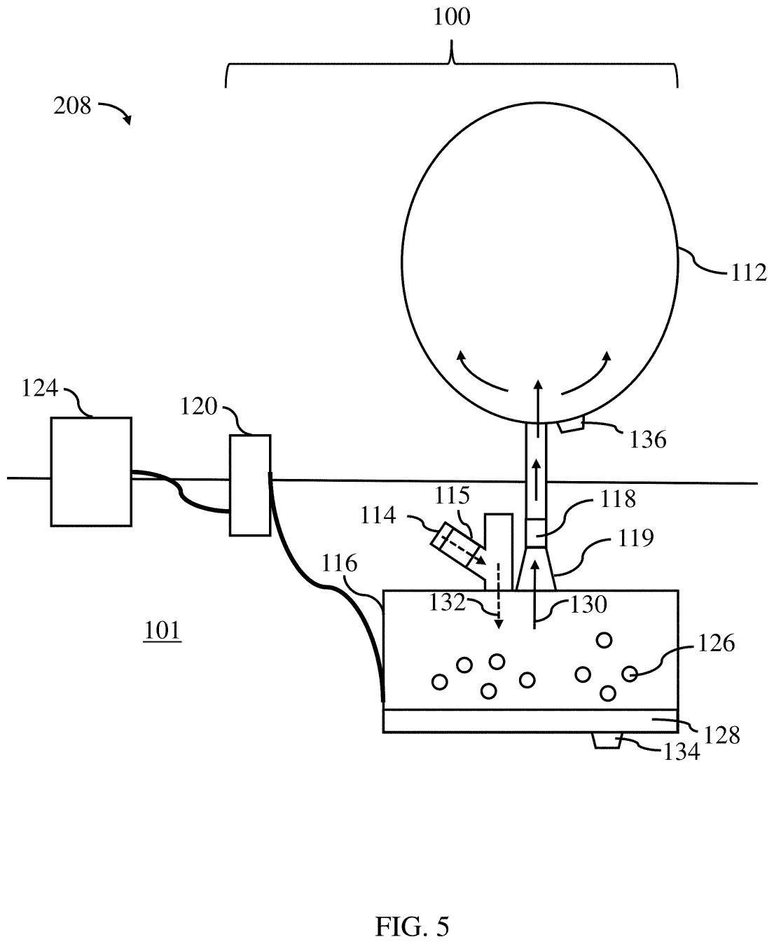

The hydrogen gas and steam (when formed) may in turn flow along the flow path indicated by arrow 130 into the balloon 112 to inflate it. Since the walls of the reaction chamber 116 are non-porous (e.g., watertight, gas tight) and the valve 115 prevents counterflow of liquid into the exterior environment 101, the generated hydrogen (and steam) may be forced to flow through the outlet 119 of the reaction chamber 116 and into the balloon 112, thereby causing the balloon 112 to inflate. Since the reactant 126 (e.g., activated aluminum), waste products (e.g., aluminum hydroxide byproducts), and reactor are heavier than the balloon 112, they would tend to sink lower than the lighter-than-air balloon 112, as shown in FIG. 5. In cases where any liquid 132 accidentally enters into the balloon 112, the valve 118 (e.g., a float valve) may cause it to drain back into the reaction chamber 116.

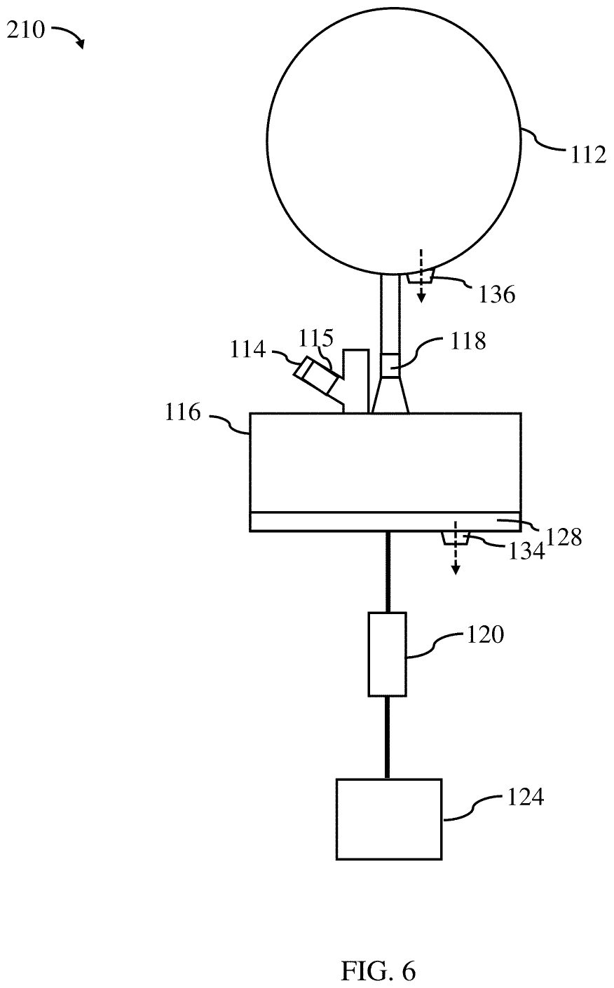

In some instances, the waste products (not shown) from the reaction may be stored as ballasts within the ballast dispensing assembly 128. As shown in FIGS. 4 and 6, once the reaction within the reaction chamber is complete, the balloon 112 has enough lift to raise the entire system, e.g., including the reaction chamber 116, the retained reaction byproduct (used subsequently as ballast), the altitude control system 120, and the payload 124, into the air.

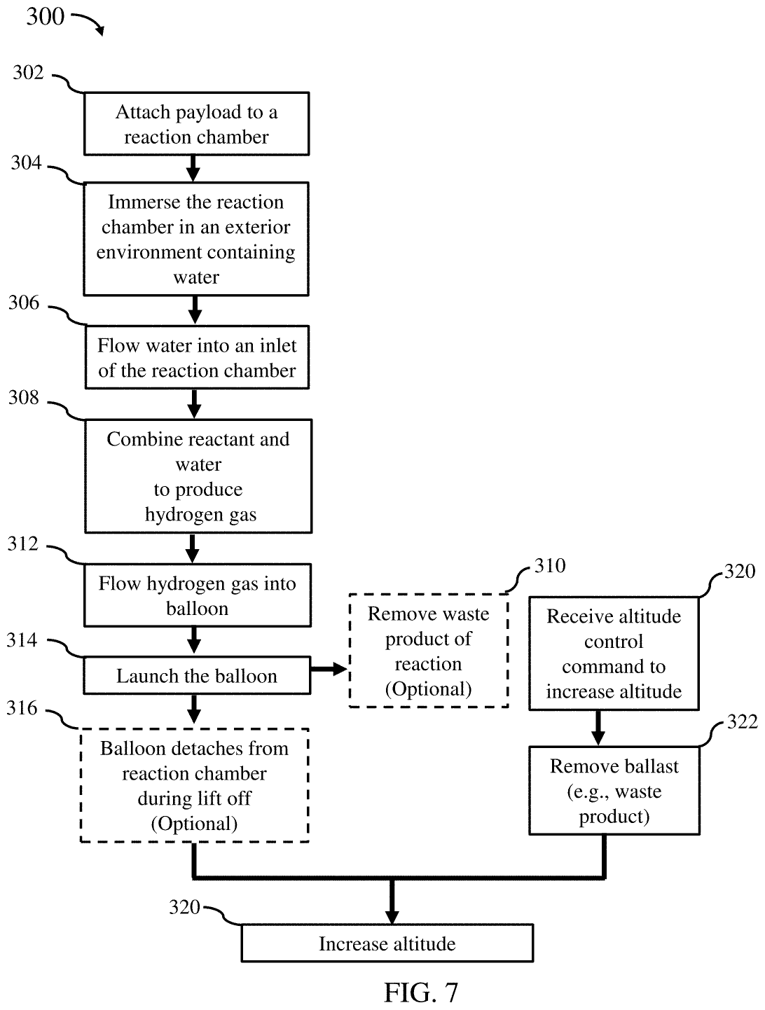

Alternatively, upon reaching a certain elapsed reaction time and/or a lift force, the balloon 112 may detached from the reaction chamber and lift off. Specific modes of altitude control during the course of flight are described in more detail below with respect to FIG. 7.

FIG. 7 is a flow diagram of one embodiment of a method 300 for filling a balloon system and controlling an altitude of the balloon system (e.g., balloon system 100 in FIG. 1). At 302, a desired payload may be attached to a part of the balloon system, e.g., such as the reaction chamber. As noted elsewhere herein and with respect to FIG. 3, the type of payload may vary depending on the type of application and may be optionally employed, in some cases, as a way to control the buoyancy of the system in the exterior environment. At 304, the reaction chamber may be at least partially immersed in an exterior environment and/or a liquid comprising water. In some instances, an inlet associated with the reaction chamber is at least partially immersed in the exterior environment. In some instances, upon immersing the reaction chamber in the exterior environment, a controller or sensor associated with the system may issue an initiation signal to the system directing the inlet and/or an associated valve to open, such that the inlet is in fluidic communication with the exterior environment. In some instances, the system may optionally comprise a sensor capable of sensing a parameter (e.g., water level, etc.) associated with the exterior environment, such that the sensor may communicate with the controller to open the inlet upon sensing the parameter. At 306, the liquid comprising water may flow in from the exterior environment into the reaction chamber via the inlet. In some cases, water may be directed into the inlet of the reaction chamber via a one way valve. The one way valve may prevent backflow of loss water from the reaction chamber into the exterior environment once the water enters into the reaction chamber. At 308, a reactant and water may be combined to produce waste products, hydrogen gas, and optionally steam, as described above in Eq. (1) and Eq. (2). The waste products may be stored in the reaction chamber (e.g., a ballast dispensing assembly) for future use as ballasts for buoyancy control during launch of the system and/or during the course of flight.

At 312, the produced hydrogen gas and steam (when formed) may be flowed into the balloon from the reactor chamber to increase a buoyancy of the balloon. For example, as shown described previously with respect to FIG. 6, to prevent the liquid (e.g., water) in the reaction chamber from entering and/or accumulating inside the balloon, one or more vents (e.g., a float valve) may be employed to drain any liquid that has entered into the balloon back into the reaction chamber. Upon filling the balloon with sufficient hydrogen gas (and steam), at 314, the balloon may be ready for takeoff.

In embodiments in which the balloon system is an integrated system, e.g., where the balloon is permanently connected to the reaction chamber, the balloon system may be launched together as a whole (e.g., as shown in FIG. 6). Alternatively, in some embodiments, at 316, the balloon may detach from the reaction chamber prior to lift off. For example, the balloon may detach from the reaction chamber based at least in part on an elapsed reaction time and/or lift force. When the elapsed reaction time and/or lift force exceed a threshold value, the balloon may be filled with an amount of gas (e.g., hydrogen and steam) sufficient for the balloon to lift off and increase in altitude, as shown in 316 and 320. Optionally, at 310, prior to the lift off, the waste product produced from the reaction may be removed from the reaction chamber via a ballast dispenser assembly (e.g., 128 in FIG. 5) to increase a buoyancy of the system.

During the course of flight (e.g., as shown in FIG. 6), in order to control the buoyancy of the balloon system, an altitude controller may send command to the system to increase altitude of the system. At 320, the altitude control command may be received by a transmitter after being sent by a remote operator, such as an operator on the ground, or the altitude control command may be generated onboard in response to, for example, various sensor readings. Controlling the altitude of the balloon may include decreasing the weight of the balloon system, decreasing a buoyancy of the balloon (i.e. venting), and/or any appropriate combination of the forgoing. FIG. 6 may be employed to illustrate one such embodiment. As shown, to decrease the buoyancy of the balloon 112, hydrogen gas (and optionally steam) may be vented from the balloon during the course of flight via a vent 136. To increase the buoyancy of the balloon, a portion of the waste products may be removed from an outlet 134 of the ballast dispenser assembly 128 located within the reaction chamber 116. In some instances, the ballast dispenser assembly 128 (e.g., rotary dispenser) may be actuated to open and release the waste products from the reaction chamber based on instructions received from the altitude controller 120.

Additionally or alternatively, in some instances, the waste product may be actively discharged from the reactor chamber 116 with one or more pumps. The pumps may be controlled by a processor. Additional sensors may sense parameters related to waste removal, such as operation of the pumps and/or the remaining capacity of the ballast dispensing assembly 128. In some embodiments, the waste product may be removed through alternative mechanisms. The waste product may be released in a controlled manner through a device such as an auger, a scooper, belt feed, or any other appropriate mechanism. By controlling the amount of waste material released from the balloon system, the amount of weight lost can be controlled, thereby altering the balance of forces on the balloon. If all other forces remain constant, decreasing the weight of the balloon system may cause the balloon system to rise or stop descending. In some embodiments, the waste product may be wet. In such embodiments, it may be desirable to warm the waste product to prevent the waste product from freezing using methods and systems similar to those described above for controlling a temperature of the reactor chamber and overall system.

Alternatively or additionally, in embodiments in which both hydrogen and steam are flowed into the balloon, the steam condensate inside the balloon may be removed as ballast during the course of flight. As described above, as the balloon increases in altitude, water condensate may be formed as a result of the steam cooling down inside the balloon due to conductive/convective heat transfer across the membrane of the balloon. As a portion of the steam condenses into water condensate, the balloon may experience a decrease in altitude. As such, a controller or sensor described herein may be used to issue an altitude control command to increase altitude. To decrease the weight of the balloon, a water condensate condensed from a portion of the steam and/or a waste product may be dropped as ballast. For instance, as disclosed above, a valve (e.g., such as a valve 136 in FIG. 6) may be actuated to open and release the water condensate based at least in part on a parameter associated with the condensate (e.g., water level, conductance, etc.). The water condensate inside the balloon may be released via a vent valve at the bottom of the balloon described herein, thus resulting in an increase in altitude.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips. GPU chips, microprocessor, microcontroller, or co-processor.

Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM. ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A system for producing hydrogen gas, the system comprising:
a reaction chamber configured to contain a reactant that reacts with water to generate hydrogen gas;
an inlet in fluid communication with an exterior environment the reaction chamber is at least partially immersed in; and
a one way valve disposed along a flow path extending between the inlet and the reaction chamber, wherein the one way valve is configured to permit a liquid to flow from the exterior environment into the reaction chamber to react the reactant with the liquid.

2. The system of claim 1, further comprising the reactant disposed in the reaction chamber.

3. The system of claim 1, wherein the reactant includes at least one selected from the group of aluminum, lithium, sodium, magnesium, zinc, boron, and beryllium.

4. The system of claim 1, wherein the reactant comprises gallium and/or indium.

5. The system of claim 1, further comprising a balloon in fluid communication with the reaction chamber, wherein the balloon is configured to detach from the reaction chamber based at least in part on an elapsed reaction time and/or a lift force.

6. The system of claim 1, further comprising a controller configured to open the inlet based at least in part on an initiation signal.

7. The system of claim 1, further comprising an altitude controller configured to control buoyancy of the system.

8. The system of claim 1, further comprising a payload attached to the system.

9. The system of claim 1, wherein the system comprises a float valve configured to prevent flow of water into the balloon.

10. The system of claim 1, wherein the system comprises a ballast.

11. The system of claim 10, wherein the ballast comprises a waste product formed by the reactant and water within the reaction chamber.

12. A method of filling a balloon, the method comprising:
immersing, at least partially, a reaction chamber in an exterior environment containing water such that water flows from the exterior environment into an inlet of the reaction chamber;
combining the water and a reactant contained within the reaction chamber to produce hydrogen gas; and
flowing the hydrogen gas into a balloon to increase a buoyancy of the balloon.

13. The method of claim 12, further comprising directing the flow of water into the inlet of the reaction chamber via a one way valve.

14. The method of claim 12, further comprising controlling a buoyancy of the balloon via one or more of a payload, a ballast, and/or an altitude controller associated with the reaction chamber.

15. The method of claim 14, further comprising removing at least a portion of a waste product formed from the reaction between the water the reactant in the reaction chamber as the ballast to an external environment.

16. The method of claim 13, further comprising detaching the balloon from the reaction chamber based at least in part on an elapsed reaction time and/or a lift force.

17. The method of claim 12, further comprising preventing flow of water into the balloon via a float valve associated with the balloon.

18. The method of claim 12, further comprising attaching a payload to the reaction chamber prior to immersing the reaction chamber in the exterior environment.

19. The method of claim 12, wherein the reactant includes at least one selected from the group of aluminum, lithium, sodium, magnesium, zinc, boron, and beryllium.

20. The method of claim 12, wherein the reactant comprises gallium and/or indium.
